(19) United States
(12) Patent Application Publication
(10) Pub. No.: US 2014/0234688 A1
(43) Pub. Date: Aug. 21, 2014

(54) BATTERY MODULE

(71) Applicants: ROBERT BOSCH GMBH, STUTTGART (DE); SAMSUNG SDI CO., LTD., Yongin-si (KR)

(72) Inventors: In-Hwan Cha, Yongin-si (KR); Seung-Woo Yang, Yongin-si (KR)

(73) Assignees: ROBERT BOSCH GMBH, STUTTGART (DE); SAMSUNG SDI CO., LTD., Yongin-si (KR)

(21) Appl. No.: 14/185,815

(22) Filed: Feb. 20, 2014

(30) Foreign Application Priority Data
Feb. 21, 2013 (KR) 10-2013-0018617

(51) Int. Cl. H01M 10/6554

(52) U.S. Cl. CPC H01M 10/5053
USPC 429/120

(57) ABSTRACT

A battery module including a plurality of battery cells, a heat exchange member and a pressure member is disclosed. The plurality of battery cells may be electrically coupled to one another. The heat exchange member may be adjacent to the battery cells. The pressure member may be configured to apply pressure to at least one of the plurality of battery cells to increase a contact force between the battery cells and the heat exchange member.

### CROSS-REFERENCE TO RELATED APPLICATION

This application claims priority to and the benefit of Korean Patent Application No. 10-2013-0018617, filed on Feb. 21, 2013, in the Korean Intellectual Property Office, the entire content of which is incorporated herein by reference.

### BACKGROUND

1. Field

An aspect of embodiments according to the present invention relates to a battery module.

2. Description of the Related Art

A high-power battery module including a non-aqueous electrolyte and having high energy density has recently been developed. The high-power battery module is configured as a large-capacity battery module manufactured by connecting a plurality of battery cells in series so as to be used for driving devices, e.g., for motors of electric vehicles and the like, which require high power.

Typically, a battery module includes a plurality of battery cells, and each battery cell provides energy to an external electronic device through an electrochemical reaction. In this case, the battery cell generates heat during the electrochemical reaction. In a case where heat is accumulated, the battery cell may be deteriorated, and the safety of the battery cell may be compromised (e.g., it may become seriously problematic). Therefore, various studies have been conducted to control the temperature of battery cells.

### SUMMARY

Aspects of embodiments according to the present invention are directed toward providing a battery module capable of improving cooling performance through a structure modification thereof.

Aspects of embodiments according to the present invention are also directed toward providing a battery module capable of reducing production cost and improving process efficiency.

According to an embodiment of the present invention, a battery module includes: a plurality of battery cells electrically coupled to one another; a heat exchange member adjacent to the battery cells; and a pressure member configured to apply pressure to at least one of the battery cells to increase a contact force between the battery cells and the heat exchange member.

At least one of the battery cells may include a cap plate including terminal portions, a bottom surface at an end opposite to the cap plate, a first side surface facing an adjacent battery cell or an exterior of the battery module, and a second side surface adjacent to the first side surface and between the cap plate and the bottom surface, and the heat exchange member may be configured to support the bottom surface of the at least one battery cell.

The pressure member may include a main body portion facing the second surface, and a pressure portion extended and bent from the main body portion so as to be configured to apply pressure to the at least one battery cell.

The pressure member may be bent toward the at least one battery cell.

The pressure member may further include a fastening portion extended and bent from the main body portion so as to be configured to be coupled to the heat exchange member.

The fastening portion may be bent away from the at least one battery cell.

The pressure member may further include an extending portion extended and bent from the pressure portion.

The extending portion may be extended toward the at least one battery cell so as to be bent in the direction of the main body portion.

The pressure member may include a plurality of main body portions, and the number of main body portions may be equal to the number of battery cells of the plurality of battery cells.

The pressure member may include a plurality of main body portions, and the number of main body portions may be smaller than the number of battery cells of the plurality of battery cells.

At least one of the main body portions may be at a boundary between two adjacent battery cells.

The battery module may further include a pair of end plates spaced apart from each other and accommodating the plurality of battery cells in a space between the end plates.

The pressure member may further include a pair of end plates spaced apart from each other and accommodating the plurality of battery cells in a space between the end plates, and the pressure member may include a plurality of main body portions and further include a connecting portion connecting adjacent main body portions and connecting the main body portions to the end plates.

The pressure member may include a metal material having elasticity.

The pressure member may include stainless steel.

As described above, according to aspects of embodiments according to the present invention, it is possible to provide a battery module capable of improving cooling performance by changing a structure in which a pressure member is applied between battery cells and a heat exchange member.

Further, according to aspects of embodiments according to the present invention, the pressure member can serve as a damper against external impact, thereby improving vibration resistance performance.

Further, according to aspects of embodiments according to the present invention, it is possible to minimize or improve the equipment tolerance of the battery cell and the heat exchange member, thereby reducing production cost and improving process efficiency.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery module according to an embodiment of the present invention.

FIG. 2A is a perspective view illustrating a single battery cell of the battery module of FIG. 1.

FIG. 2B is a development view illustrating a pressure member of the battery module of FIG. 1.

FIG. 2C is a cross-sectional view taken along line A-A of FIG. 1.

FIG. 3 is a perspective view of a battery module according to another embodiment of the present invention.

FIG. 4 is a perspective view of a battery module according to still another embodiment of the present invention.

FIG. 5 is a perspective view of a battery module according to still another embodiment of the present invention.

FIG. 6 is a cross-sectional view illustrating a pressure member of a battery module according to still another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

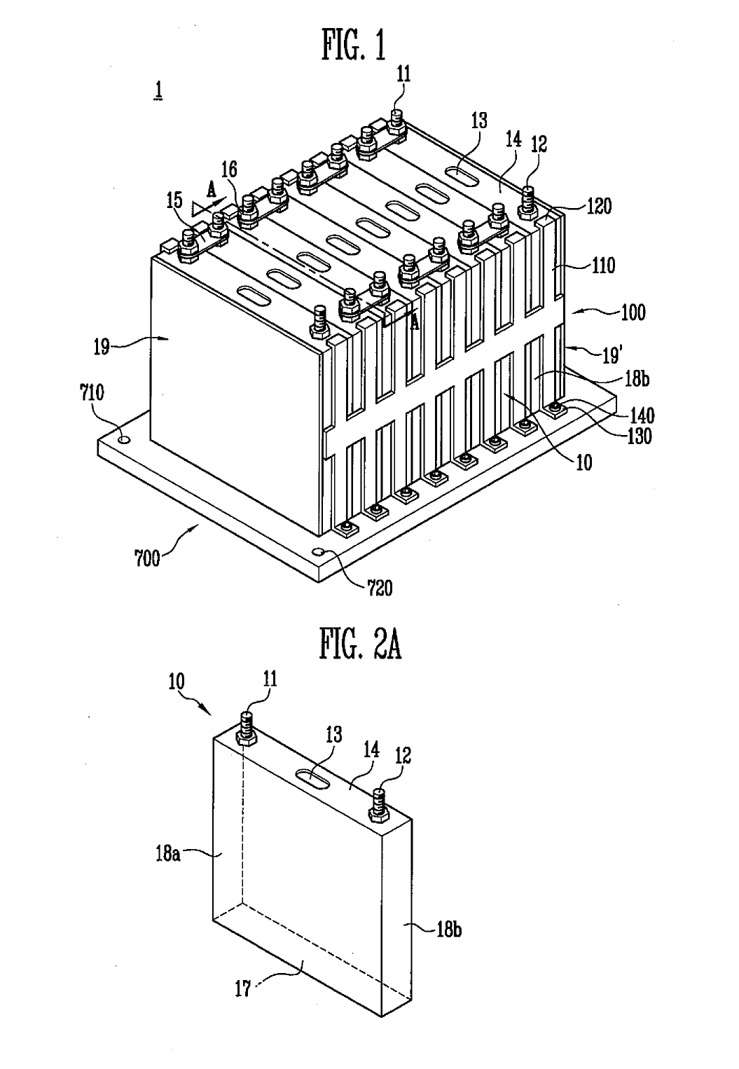

FIG. 1 is a perspective view of a battery module according to an embodiment of the present invention.

The battery module 1 according to this embodiment includes a plurality of battery cells 10 electrically connected to (e.g., electrically coupled to) one another; a heat exchange member 700 adjacent to (e.g., under) the battery cells 10; and a pressure member 100 for applying pressure to the battery cells 10 so that the contact force between the battery cells 10 and the heat exchange member 700 is improved (e.g., increased).

Referring to FIG. 1, the battery cell 10 may include a battery case having one opened surface, and an electrode assembly and an electrolyte, which are accommodated (e.g., housed) in the battery case. The electrode assembly and the electrolyte generate energy through an electrochemical reaction therebetween, and the battery case is sealed by a cap plate 14. The cap plate 14 may include terminal portions 11 and 12 and a vent portion 13. The terminal portions 11 and 12 may include positive and negative electrode terminals 11 and 12, respectively, having different polarities. The vent portion 13 is a safety device of the battery cell 10, and serves as a passage through which gas generated inside the battery cell 10 can be exhausted to the outside of the battery cell 10. The positive and negative electrode terminals 11 and 12 of adjacent battery cells 10 may be electrically connected to (e.g., electrically coupled to) each other by a bus-bar 15. The bus-bar 15 may be fixed to the positive and negative electrode terminals 11 and 12 by a member such as a nut 16.

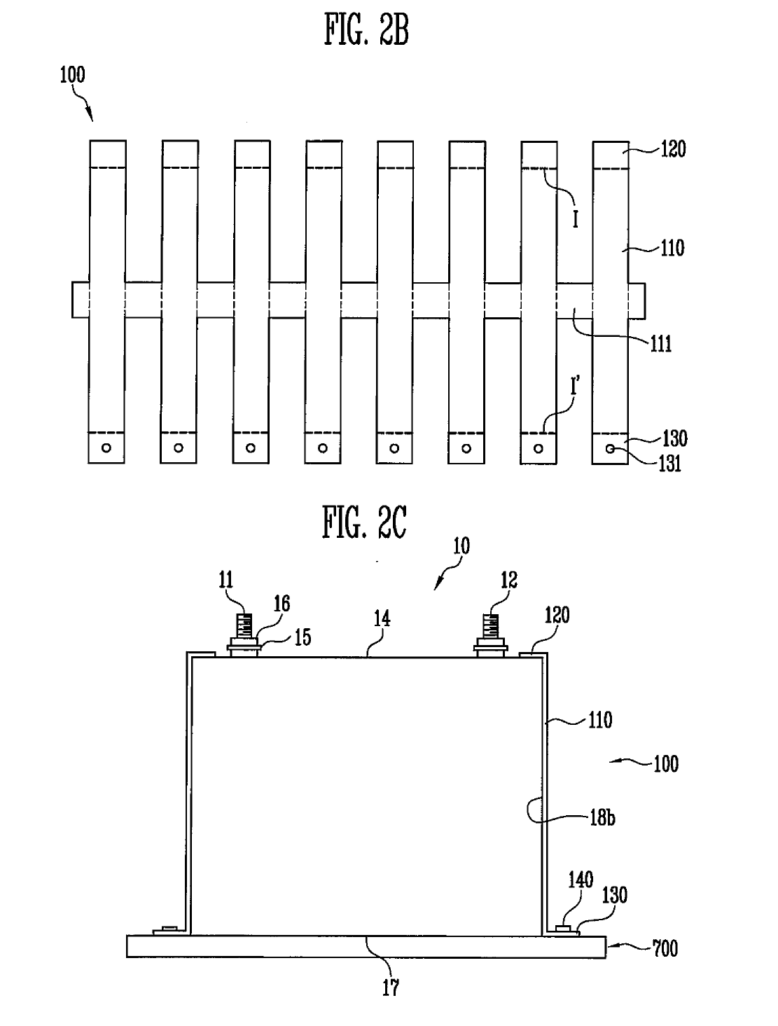

The battery cell 10 may be arranged in plural numbers (e.g., the battery module 1 may include a plurality of battery cells 10). In this case, end plates 19 and 19′ may be used to fix the arrangement of the battery cells 10 (e.g., to secure the battery cells 10 in place with respect to the battery module 1). The end plates 19 and 19′ are located opposite to each other (e.g., spaced apart from each other), so as to respectively face a first side surface 18a (see FIG. 2A) that is a wide surface of the outermost battery cell 10 and a side surface facing away from the first side surface 18a. The end plates 19 and 19′ allow the plurality of battery cells 10 to be fixed (e.g., fixed in place with respect to the battery module 1). The end plates 19 and 19′ may be variously modified according to the design of the battery module 1.

The pressure member 100 includes a main body portion 110 facing a second side surface 18b (see FIG. 2C) of the battery cell 10, a pressure portion 120 extended and bent from the main body portion 110 so as to apply pressure to the battery cell 10, a fastening portion 130 extended and bent from the main body portion 110 so as to be coupled to the heat exchange member 700, and a connecting portion 111 (see FIG. 2B) connecting adjacent main body portions 110 and connecting the adjacent main body portions 110 to the end plates 19 and 19′. Here, the pressure portion 120 is bent in the direction of (e.g., toward) the battery cell 10 so as to apply pressure to the battery cell 10, and the fastening portion 130 is bent in a direction opposite to (e.g., away from) the battery cell 10 so as to be fastened to the heat exchange member 700 by a fastening member 140.

The pressure member 100 may include a metal material having elasticity, and may include, for example, stainless steel.

In the battery module 1 according to this embodiment, the pressure member 100 is provided so that the number of the main body portions 110 is the same as (e.g., equal to) that of the battery cells 10. For example, the pressure member 100 is provided so that the battery cells and the main body portions 110 face each other, thereby pressing (e.g., applying pressure to) the battery cells 10.

FIG. 2A is a perspective view illustrating the battery cell of FIG. 1. FIG. 2B is a development view illustrating a pressure member of FIG. 1. FIG. 2C is a cross-sectional view taken along line A-A of FIG. 1.

Referring to FIG. 2A, the battery cell 10 includes a cap plate 14 including the terminal portions 11 and 12 and the vent portion 13, and the battery cell 10 includes a bottom surface 17 at an end opposite to the cap plate 14. The battery cell 10 further includes a first side surface 18a that is a wide surface facing one of an adjacent battery cell 10 or an exterior of the battery module, and a second side surface 18b adjacent to the first side surface 18a and located between the cap plate 14 and the bottom surface 17.

Referring to FIGS. 2B and 2C, the pressure member 100 includes the main body portion 110 provided to face the second side surface 18b of the battery cell 10, the pressure portion 120 extended and bent from the main body portion 110 so as to apply pressure to the battery cell 10, the fastening portion 130 extended and bent from the main body portion 110 so as to be coupled to the heat exchange member 700, and the connecting portion 111 connecting adjacent main body portions 110 and connecting the adjacent main body portions 110 to the end plates 19 and 19′. Here, in this embodiment, a fastening hole 131 is provided in the fastening portion 130 to be fastened to the heat exchange member 700 therethrough. The pressure portion 120 is bent in the direction of (e.g., toward) the battery cell 10 along a first bending line I so as to apply pressure to the battery cell 10, and the fastening portion 130 is bent in the direction opposite to (e.g., away from) the battery cell 10 so as to be fastened to the heat exchange member 700 by the fastening member 140.

Meanwhile, the heat exchange member 700 may support the bottom surface 17 (e.g., the surface opposite to the cap plate 14) of the battery cell 10. The heat exchange member 700 is implemented using a liquid-cooled (e.g., water-cooled) method so that a refrigerant (e.g., a liquid) is flowed in the heat exchange member 700 through an inlet 710 (see FIG. 1) and then flowed out from the heat exchange member 700 through an outlet 720 (see FIG. 1). The refrigerant contacts (e.g., indirectly contacts) the battery cells 10 by the medium of the heat exchange member 700 while flowing along a flow path inside the heat exchange member 700, thereby performing heat conduction (e.g., to remove heat from and cool the battery cell 10).

In a water-cooled battery module, if a battery cell generates heat, an amount of the generated heat may be removed by a heat exchange member. However, since the battery cell and the heat exchange member come in physical contact with each other, a change in heat transfer performance depends upon the degree of contact between the battery cell and the heat exchange member. For example, in a case where the contact state is poor (e.g., the degree of contact between the battery cell and the heat exchange member is low), the heat transfer performance is remarkably lowered. Because the contact state between the battery cell and the heat exchange member can depend on equipment tolerance, such as design tolerance, manufacturing tolerance or assembling tolerance, in previous battery modules a high-priced thermal interface material (TIM) has been applied between the battery cell and the heat exchange member so as to maintain heat transfer performance. On the other hand, in the battery module 1 according to the present embodiment, heat transfer performance, e.g., cooling performance, can be improved by changing a structure in which the pressure member 100 is applied adjacent to (or between) the battery cell 10 and the heat exchange member 700. Further, the heat exchange member 700 can serve as a damper against external impact, thereby improving vibration resistance performance of the battery module. Meanwhile, the equipment tolerance of the battery cell and the heat exchange member can be minimized (or reduced), thereby reducing production cost and improving process efficiency.

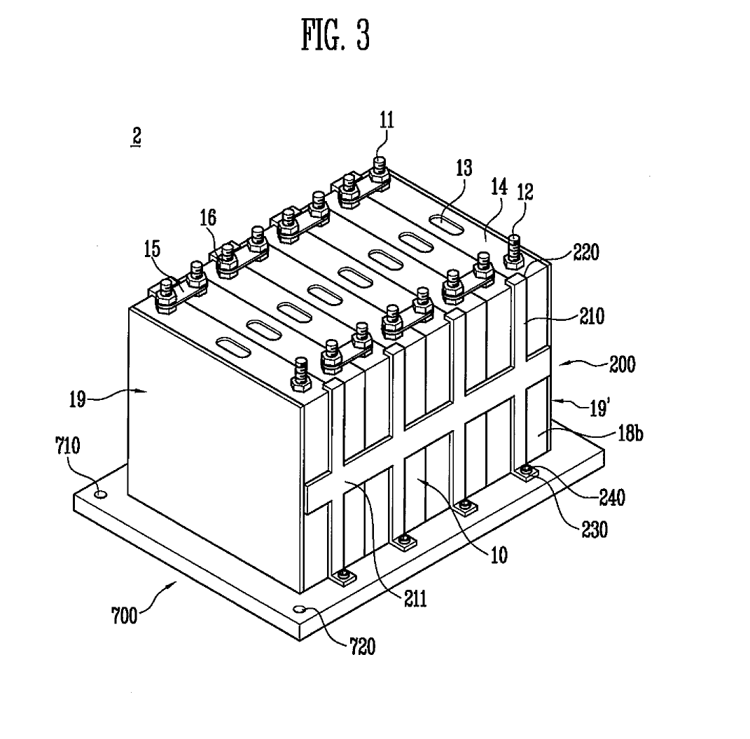

Hereinafter, other embodiments of the present invention will be described with reference to FIGS. 3 to 6. Certain features of these embodiments, with the exception of the following features, are similar to those of the embodiment described with reference to FIGS. 1 to 2C, and therefore, their repeated detailed descriptions will be omitted here.

FIG. 3 is a perspective view of a battery module 2 according to another embodiment of the present invention.

Referring to FIG. 3, a pressure member 200 includes a main body portion 210 facing the second side surface 18b (e.g., the narrow side surface) of the battery cell 10, a pressure portion 220 extended and bent from the main body portion 210 so as to apply pressure to the battery cell 10, a fastening portion 230 extended and bent from the main body portion 210 so as to be coupled to the heat exchange member 700, and a connecting portion 211 connecting adjacent main body portions 210 and connecting the adjacent main body portions 210 to the end plates 19 and 19′. Here, in this embodiment, the pressure portion 220 is bent in the direction of (e.g., toward) the battery cell 10 so as to apply pressure to the battery cell 10, and the fastening portion 230 is bent in a direction opposite to (e.g., away from) the battery cell 10 so as to be fastened to the heat exchange member 700 by a fastening member 240.

In the battery module 2 according to this embodiment, the pressure member 200 is provided so that the number of the main body portions 210 is smaller than that of the battery cells 10. The main body portion 210 is provided on (e.g., at) a boundary (e.g., an interface) between adjacent battery cells 10. For example, the pressure member 200 is provided (or located) so that each main body portion 210 faces between adjacent battery cells 10, thereby each main body portion 210 applies pressure to two battery cells 10.

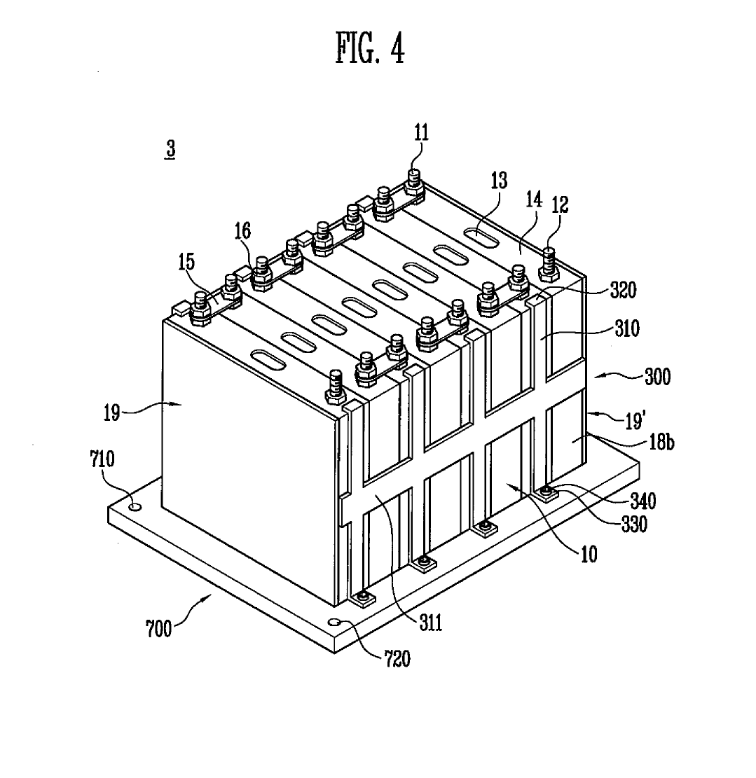

FIG. 4 is a perspective view of a battery module 3 according to still another embodiment of the present invention.

Referring to FIG. 4, a pressure member 300 includes a main body portion 310 facing the second side surface 18b (e.g., the narrow side surface) of the battery cell 10, a pressure portion 320 extended and bent from the main body portion 310 so as to apply pressure to the battery cell 10, a fastening portion 330 extended and bent from the main body portion 310 so as to be coupled to the heat exchange member 700, and a connecting portion 311 connecting adjacent main body portions 310 and connecting the adjacent main body portions 310 to the end plates 19 and 19′. Here, in this embodiment, the pressure portion 320 is bent in the direction of (e.g., toward) the battery cell 10 so as to apply pressure to the battery cell 10, and the fastening portion 330 is bent in a direction opposite to (e.g., away from) the battery cell 10 so as to be fastened to the heat exchange member 700 by a fastening member 340.

In the battery module 3 according to this embodiment, the pressure member 300 is provided so that the number of the main body portions 310 is smaller than that of the battery cells 10. For example, as shown in FIG. 4, the main body portions 310 are provided on odd-numbered battery cells 10, as numbered from the front end plate 19.

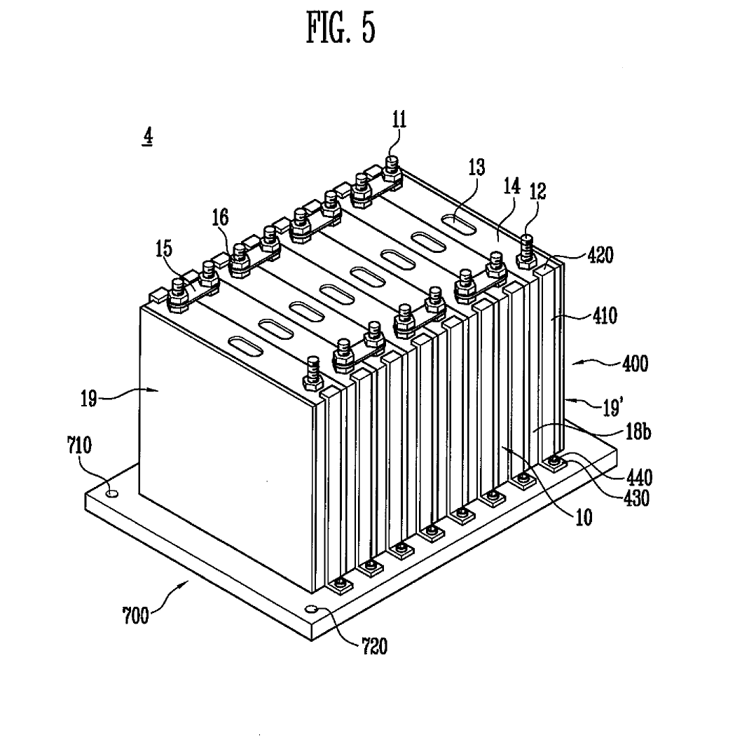

FIG. 5 is a perspective view of a battery module 4 according to still another embodiment of the present invention.

Referring to FIG. 5, a pressure member 400 includes a main body portion 410 facing the second side surface 18b (e.g., the narrow side surface) of the battery cell 10, a pressure portion 420 extended and bent from the main body portion 410 so as to apply pressure to the battery cell 10, and a fastening portion 430 extended and bent from the main body portion 410 so as to be coupled to the heat exchange member 700. Here, in this embodiment, the pressure portion 420 is bent in the direction of (e.g., toward) the battery cell 10 so as to apply pressure to the battery cell 10, and the fastening portion 430 is bent in a direction opposite to (e.g., away from) the battery cell 10 so as to be fastened to the heat exchange member 700 by a fastening member 440. Unlike the embodiments shown in FIGS. 1 to 4, the pressure member 400 according to this embodiment does not have a connecting portion connecting adjacent main body portions 410 or connecting the adjacent main body portions 410 to the end plates 19 and 19′.

In the battery module 4 according to this embodiment, like the embodiment shown in FIGS. 1 to 2C, the pressure member 400 is provided so that the number of the main body portions 410 is the same as (e.g., equal to) that of the battery cells 10. For example, the pressure member 400 is provided so that the main body portions 410 face the respective battery cells 10, thereby applying pressure to (e.g., pressing) the battery cells 10.

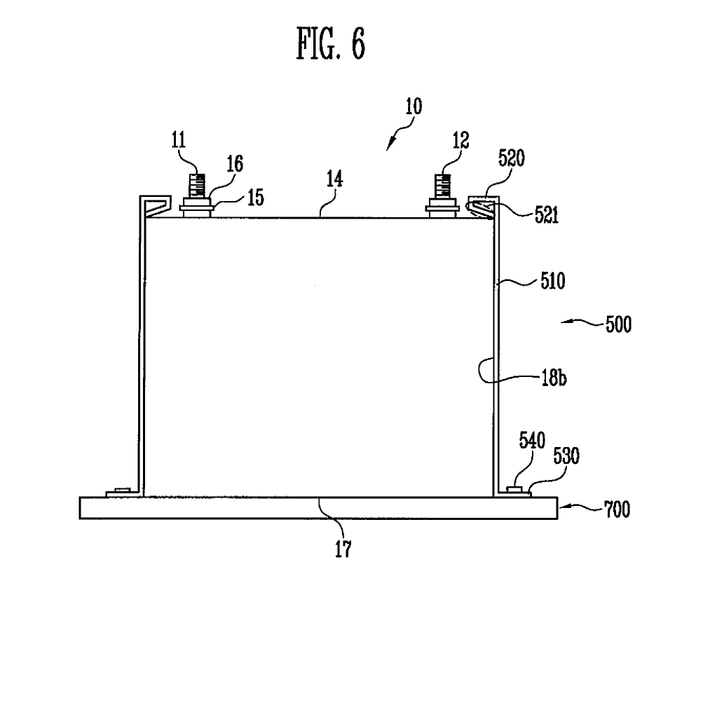

FIG. 6 is a cross-sectional view illustrating a pressure member 500 in a battery module according to still another embodiment of the present invention.

Referring to FIG. 6, the pressure member 500 includes a main body portion 510 facing the second side surface 18b (e.g., the narrow side surface) of the battery cell 10, a pressure portion 520 extended and bent from the main body portion 510 so as to apply pressure to the battery cell 10, an extending portion 521 extended and bent from the pressure portion 520, and a fastening portion 530 extended and bent from the main body portion 510 so as to be coupled to the heat exchange member 700. Here, in this embodiment, the pressure portion 520 and the extending portion 521 are bent in the direction of (e.g., toward) the battery cell 10 and bent in the direction of the main body portion 510 so as to apply pressure to the battery cell 10. The fastening portion 530 is bent in a direction opposite to the battery cell 10 so as to be fastened to the heat exchange member 700 by a fastening member 540.

The extending portion 521 of the pressure member 500 according to this embodiment does not have a structure bonded to the main body portion 510, and includes (e.g., is made of) a metal material having elasticity. Thus, it is possible to reduce the height of the battery cell 10 and the equipment tolerance of the pressure member 500, and to apply a greater pressure to the battery cell 10 and the heat exchange member 700, thereby improving heat transfer performance (e.g., cooling performance).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery module, comprising:
a plurality of battery cells electrically coupled to one another;
a heat exchange member adjacent to the battery cells; and
a pressure member configured to apply pressure to at least one of the plurality of battery cells to increase a contact force between the battery cells and the heat exchange member.

2. The battery module of claim 1, wherein the at least one battery cell comprises a cap plate comprising terminal portions, a bottom surface at an end opposite to the cap plate, a first side surface facing an adjacent battery cell or an exterior of the battery module, and a second side surface adjacent to the first side surface and between the cap plate and the bottom surface, and
wherein the heat exchange member is configured to support the bottom surface of the at least one battery cell.

3. The battery module of claim 2, wherein the pressure member comprises a main body portion facing the second surface, and a pressure portion extended and bent from the main body portion so as to be configured to apply pressure to the at least one battery cell.

4. The battery module of claim 3, wherein the pressure member is bent toward the at least one battery cell.

5. The battery module of claim 3, wherein the pressure member further comprises a fastening portion extended and bent from the main body portion so as to be configured to be coupled to the heat exchange member.

6. The battery module of claim 5, wherein the fastening portion is bent away from the at least one battery cell.

7. The battery module of claim 3, wherein the pressure member further comprises an extending portion extended and bent from the pressure portion.

8. The battery module of claim 7, wherein the extending portion is extended toward the at least one battery cell so as to be bent in the direction of the main body portion.

9. The battery module of claim 1, wherein the pressure member comprises a plurality of main body portions, and the number of main body portions is equal to the number of battery cells of the plurality of battery cells.

10. The battery module of claim 1, wherein the pressure member comprises a plurality of main body portions, and the number of main body portions is smaller than the number battery cells of the plurality of battery cells.

11. The battery module of claim 10, wherein at least one of the main body portions is at a boundary between two adjacent battery cells.

12. The battery module of claim 1, further comprising a pair of end plates spaced apart from each other and accommodating the plurality of battery cells in a space between the end plates.

13. The battery module of claim 12, wherein the pressure member comprises a plurality of main body portions and further comprises a connecting portion connecting adjacent main body portions and connecting the main body portions to the end plates.

14. The battery module of claim 1, wherein the pressure member comprises a metal material having elasticity.

15. The battery module of claim 14, wherein the pressure member comprises stainless steel.
